(19) United States
(12) Patent Application Publication
(10) Pub. No.: US 2011/0142039 A1
(43) Pub. Date: Jun. 16, 2011

(54) PACKET TRANSFER APPARATUS AND METHOD AND LOCATION MANAGEMENT APPARATUS AND METHOD FOR ENSURING CONTINUITY OF PACKET DELIVERY

(75) Inventor: Hee-Young JUNG, Daejeon-si (KR)

(73) Assignee: Electronics and Telecommunications Research Institute, Daejeon (KR)

(21) Appl. No.: 12/911,242

(22) Filed: Oct. 25, 2010

(30) Foreign Application Priority Data
Dec. 15, 2009 (KR) 10-2009-0125127
Jul. 5, 2010 (KR) 10-2010-0064521

(51) Int. Cl. H04L 12/56

(52) U.S. Cl. 370/389

(57) ABSTRACT

Provided is a packet transfer method for ensuring continuity of packet delivery. The method includes: identifying whether a packet transfer apparatus is connected to a mobile host when requested by a location management apparatus to transfer a packet to the mobile host; reporting to the location management apparatus that the packet transfer apparatus is disconnected from the mobile host when it is identified that the packet transfer apparatus is disconnected from the mobile host; and storing the packet which has been requested for transfer to the mobile host. The packet transfer method can achieve lossless packet transmission by preventing a loss of important packets without the addition of a new common layer, despite intermittent disconnections in a mobile Internet environment.

### CROSS-REFERENCE TO RELATED APPLICATION(S)

This application claims the benefit under 35 U.S.C. §119(a) of Korean Patent Application Nos. 10-2009-0125127, filed on Dec. 15, 2009, and 10-2010-0064521, filed on Jul. 5, 2010, the entire disclosures of which are incorporated herein by references for all purposes.

### BACKGROUND

1. Field

The following description relates to a packet delivery method, and particularly, to a packet transfer method for ensuring continuity of ensuring packet delivery.

2. Description of the Related Art

With the development of wireless and mobile communication technologies, a wireless and mobile host method is expected to predominate in the future Internet environment by replacing a fixed host method.

In a wireless environment, however, a host may be disconnected from the Internet for a relatively long time, for example, because the host enters a power-saving mode or due to network connection problems.

The conventional Internet was designed assuming stable connectivity. Thus, when a host is disconnected from the Internet, it is fundamentally impossible to transmit a packet to the host. Therefore, there is a risk that data containing important information will not be delivered to the host.

To solve this problem, technologies such as delay-tolerant networking (DTN) have been suggested. DTN is an approach that delivers messages in a store-and-forward manner in order to reduce a loss of transmission data in a situation where continuous end-to-end connectivity is not guaranteed. In the case of DTN, however, a host and each node of a network must have a bundle layer, which is a new common layer, between a transmission layer and an application layer.

### SUMMARY

The following description relates to a packet transfer method which can prevent packet loss without the addition of a new common layer, despite intermittent disconnections in Internet and future Internet environments.

In one general aspect, there is provided a packet transfer method for ensuring continuity of packet delivery. The method includes: identifying whether a packet transfer apparatus is connected to a mobile host when requested by a location management apparatus to transfer a packet to the mobile host; reporting to the location management apparatus that the packet transfer apparatus is disconnected from the mobile host when it is identified that the packet transfer apparatus is disconnected from the mobile host; and storing the packet which has been requested for transfer to the mobile host.

In another aspect, there is provided a packet transfer apparatus for ensuring continuity of packet delivery. The apparatus includes: a state identification unit identifying whether a packet transfer apparatus is connected to a mobile host when requested by a location management apparatus to transfer a packet to the mobile host; a state reporting unit reporting to the location management apparatus that the packet transfer apparatus is disconnected from the mobile host when it is identified that the packet transfer apparatus is disconnected from the mobile host; a packet storage unit storing packets which are to be transferred to mobile hosts; and a packet management unit storing the packet, which has been requested for transfer to the mobile host, in the packet storage unit.

In another aspect, there is provided a method of managing the position of a mobile host to ensure continuity of packet delivery. The method includes: matching information about a mobile host with information about a packet transfer apparatus which is disconnected from the mobile host and storing the matched information when receiving from the packet transfer apparatus a message informing that the packet transfer apparatus is disconnected from the mobile host to which a packet must be transferred; and providing information about the packet transfer apparatus which is disconnected from the mobile host when reported by another packet transfer apparatus that the mobile host is connected to the another packet transfer apparatus.

In another aspect, there is provided an apparatus for managing the position of a mobile host to ensure continuity of packet delivery. The apparatus includes: a position information storage unit configured to store information about the position of a mobile host and information about a packet transfer apparatus to which the mobile host belongs; a position information management unit configured to manage information stored in the position information storage unit and, when receiving from a packet transfer apparatus a message informing that the packet transfer apparatus is disconnected from a mobile host to which a packet must transferred, store information about the disconnection of the packet transfer apparatus from the mobile host in the position information storage unit; and a position information provision unit configured to extract the information about the packet transfer apparatus which is disconnected from the mobile host and provide the extracted information to another packet transfer apparatus when reported by the another packet transfer apparatus that the mobile host is connected to the another packet transfer apparatus.

Other features and aspects will be apparent from the following detailed description, the drawings, and the claims.

### BRIEF DESCRIPTION OF THE DRAWINGS

FIG. 1 is a diagram illustrating the configuration of an exemplary Internet system;

FIG. 2 is a diagram illustrating the configuration of an exemplary packet transfer apparatus;

FIG. 3 is a diagram illustrating the configuration of an exemplary location management apparatus;

FIG. 4 is a flowchart illustrating an exemplary packet transfer method for ensuring continuity of packet delivery;

FIG. 5 is a flowchart illustrating an exemplary method of managing the position of a mobile host to ensure continuity of packet delivery;

FIG. 6 is a diagram illustrating the configuration of an exemplary packet transfer system for ensuring continuity of packet delivery;

FIG. 7 is a flowchart illustrating an exemplary packet transfer method used in a mobile Internet system to ensure continuity of packet delivery;

FIG. 8 is a diagram illustrating the configuration of another exemplary packet transfer system for ensuring continuity of packet delivery; and

FIG. 9 is a flowchart illustrating another exemplary packet transfer method used in a future Internet to ensure continuity of packet delivery.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above and other features and advantages of the present invention will become more apparent by describing in detail exemplary embodiments thereof with reference to the attached drawings. These exemplary embodiments of the present invention will hereinafter be described more fully to convey the concept of the invention to those of ordinary skill in the art.

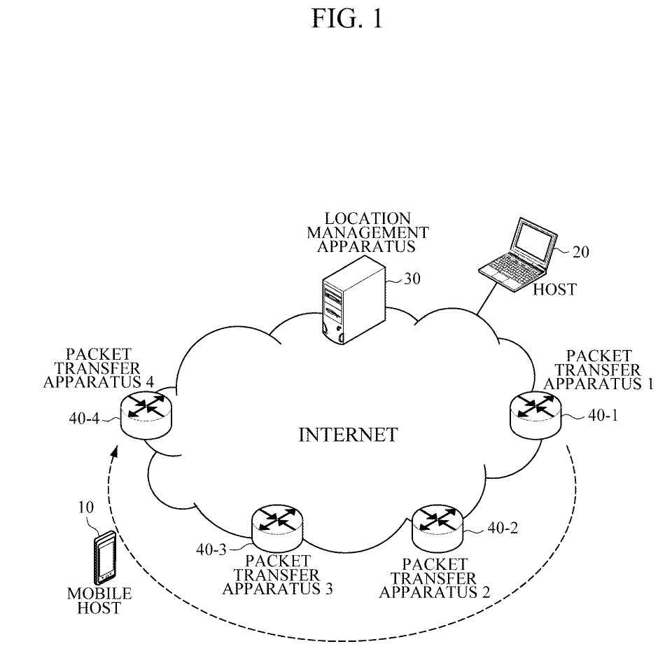

FIG. 1 is a diagram illustrating the configuration of an exemplary Internet system. Referring to FIG. 1, the exemplary Internet system includes a location management apparatus 30 and first through fourth packet transfer apparatuses 40-1 through 40-4, all of which are connected to each other through the Internet.

The packet transfer apparatuses 40-1 through 40-4 may be edge routers.

For example, a mobile host 10 may move from the first packet apparatus 40-1 to the fourth packet transfer apparatus 40-4 via the second and third packet transfer apparatuses 40-2 and 40-3. In this case, it is assumed that the mobile host 10 cannot connect to the second and third packet transfer apparatuses 40-2 and 40-3 when passing through service areas of the second and third packet transfer apparatuses 40-2 and 40-3. That is, the mobile host 10 may be disconnected from the second and third packet transfer apparatuses 40-2 and 40-3, for example, due to an unstable communication environment or because the mobile host 10 enters a sleep mode to save power. Thus, when the mobile host 10 is located in the service area of the second or third packet transfer apparatus 40-2 or 40-3, a transmitted packet may not be delivered to the mobile host 10. That is, there is a risk that a packet containing important information will be lost without being delivered to the mobile host 10.

In the current exemplary embodiment, to deal with intermittent disconnections, the location management apparatus 30 must perform additional signaling and a database update. In the case of mobile IP, position information is managed in a soft state.

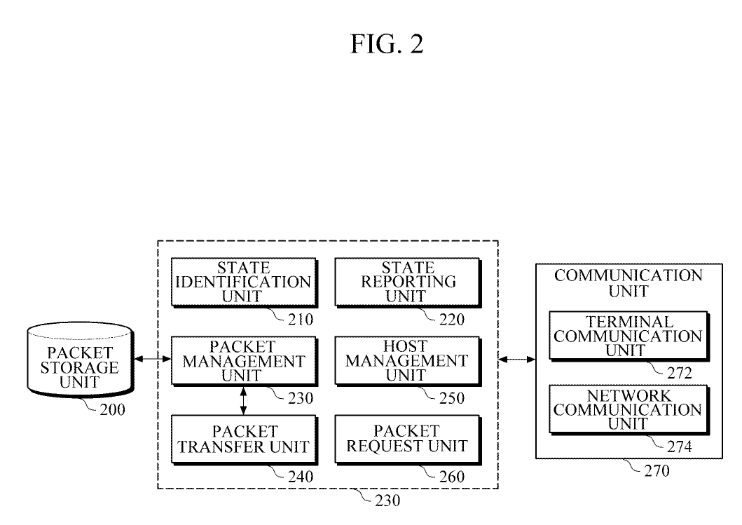

FIG. 2 is a diagram illustrating the configuration of an exemplary packet transfer apparatus. Referring to FIG. 2, the exemplary packet transfer apparatus may be implemented as one of an access node, a foreign agent, and a router. As shown in FIG. 2, the exemplary packet transfer apparatus includes a packet storage unit 200, a state identification unit 210, a state reporting unit 220, a packet management unit 230, a package transfer unit 240, a host management unit 250, a packet request unit 260, and a communication unit 270.

The packet storage unit 200 is implemented as a conventional memory device. For example, the packet storage unit 200 may be implemented as a buffer. In the current exemplary embodiment, the packet storage unit 200 stores a packet that is to be transferred to a mobile host which is disconnected from the exemplary packet transfer apparatus. The packet storage unit 200 temporarily stores the packet until the disconnected mobile host gets connected to another packet transfer apparatus in a stable manner.

The state identification unit 210 identifies whether the exemplary packet transfer apparatus is connected to a mobile host when requested by a home agent or a host to transfer a packet to the mobile host. When the state identification unit 210 determines that the exemplary packet transfer apparatus is disconnected from the mobile host to which the packet must be transferred, the state reporting unit 220 reports this information to the location management apparatus.

The packet management unit 230 stores the packet, which has been requested for transfer to the disconnected mobile host, in the packet storage unit 200. When requested by another packet transfer apparatus to forward the stored packet, the packet management unit 230 extracts the packet from the packet storage unit 200.

The packet transfer unit 240 forwards the packet, which is extracted by the packet management unit 230 in response to the packet forward request, to the packet transfer apparatus which made the packet forward request. In addition, the packet transfer unit 240 receives a packet, which is destined for a mobile host currently connected to the exemplary packet transfer apparatus, from another packet transfer apparatus and transfers the received packet to the mobile host.

When a new mobile host enters the service area of the exemplary packet transfer apparatus, the host management unit 250 reports the position information of the new mobile host to the location management apparatus.

The packet request unit 260 receives from the location management apparatus a message informing about the existence of a packet that must be delivered to a mobile host and information about a packet transfer apparatus which stores the packet. Accordingly, the packet request unit 260 requests the packet transfer apparatus, which stores the packet, to forward the stored packet.

The communication unit 270 includes a terminal communication unit 272 and a network communication unit 274. In the current exemplary embodiment, the terminal communication unit 272 communicates with terminals located in a service area of the exemplary packet transfer apparatus, and the network communication unit 274 communicates with network apparatuses such as a location management apparatus and other packet transfer apparatuses.

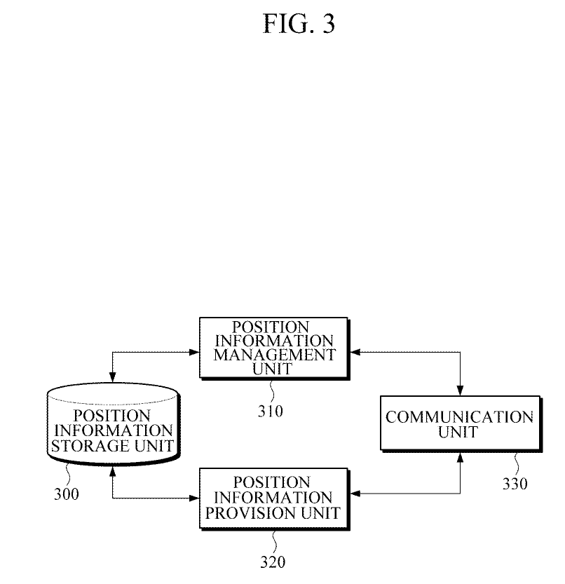

FIG. 3 is a diagram illustrating the configuration of an exemplary location management apparatus. Referring to FIG. 3, the location management apparatus may be implemented as a home agent. In the current exemplary embodiment, the location management apparatus includes a position information storage unit 300, a position information management unit 310, a position information provision unit 320, and a communication unit 330.

The position information storage unit 300 stores the position information of a mobile host and information about a packet transfer apparatus to which the mobile host belongs.

The communication unit 330 communicates with other packet transfer apparatuses through a network.

The position information management unit 310 manages information stored in the position information storage unit 300. In the current exemplary embodiment, when receiving from a packet transfer apparatus a message informing that the packet transfer apparatus is disconnected from a mobile host to which a packet must be transferred, the position information management unit 310 stores information about the disconnection of the packet transfer apparatus from the mobile host in the position information storage unit 300.

When reported by another packet transfer apparatus that the mobile host to which the packet must be transferred is connected to the another packet transfer apparatus, the position information provision unit 320 extracts information about the packet transfer apparatus which is disconnected from the mobile host and provides the extracted information to the another packet transfer apparatus which is connected to the mobile host.

When reported by a packet transfer apparatus that the mobile host is connected to the packet transfer apparatus, the position information management unit 310 creates a database of the position information of the mobile host and stores the database in the position information storage unit 300. In addition, when requested by the host to provide the position information of a mobile host, the position information management unit 310 provides the position information of the mobile host.

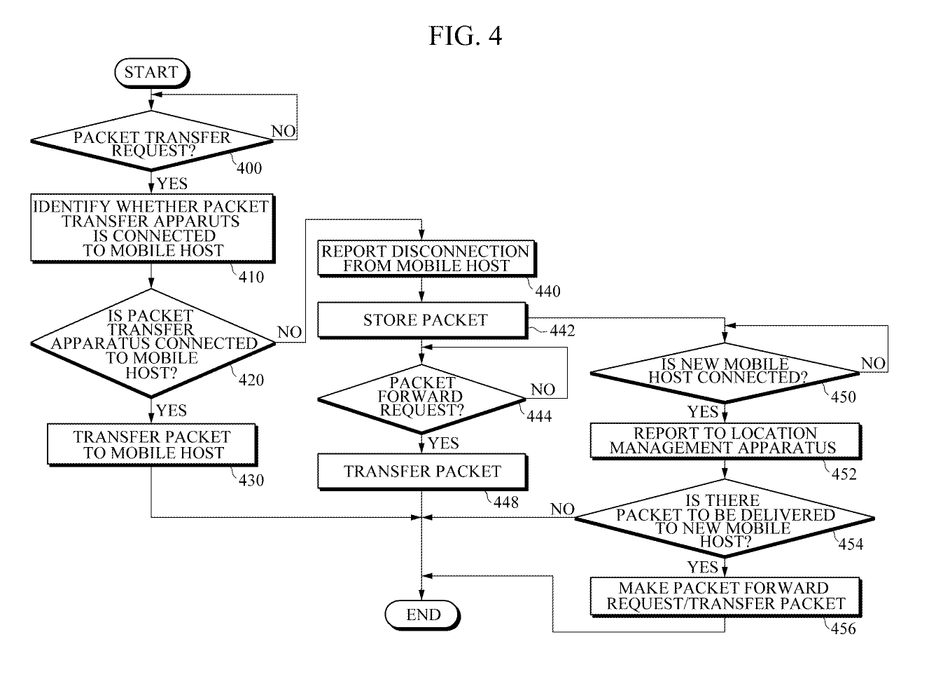

FIG. 4 is a flowchart illustrating an exemplary packet transfer method for ensuring continuity of packet delivery. The exemplary packet transfer method is performed by a packet transfer apparatus such as a foreign agent or an access router.

Referring to FIGS. 2 and 4, when requested by a host to transfer a packet (400), the state identification unit 210 identifies whether the packet transfer apparatus is connected to a mobile host to which the packet must be transferred (410). When it is identified that the packet transfer apparatus is connected to the mobile host (420), the packet transfer unit 240 transfers the packet to the mobile host (430). On the other hand, when it is identified that the packet transfer apparatus is not connected to the mobile host, the state reporting unit 220 reports this information to a location management apparatus (440). Then, the packet management unit 230 stores the packet, which has been requested for transfer to the mobile host, in the packet storage unit 200 (442). When requested by another packet transfer apparatus to forward the packet (444), the packet transfer unit 230 forwards the packet stored in the packet storage unit 200 to the another packet transfer apparatus which made the packet forward request (448).

When receiving a connection request from a new mobile host (450), the host management unit 250 reports the access of the new mobile host to the location management apparatus (452). When receiving a message informing about the existence of a packet undelivered to the new mobile host and information about a packet transfer apparatus which stores the undelivered packet (454), the packet request unit 260 requests the packet transfer apparatus which stores the undelivered packet to forward the undelivered packet. Then, the packet transfer unit 240 receives the undelivered packet from the packet transfer apparatus which stores the undelivered packet and sends the received packet to the new mobile host (456).

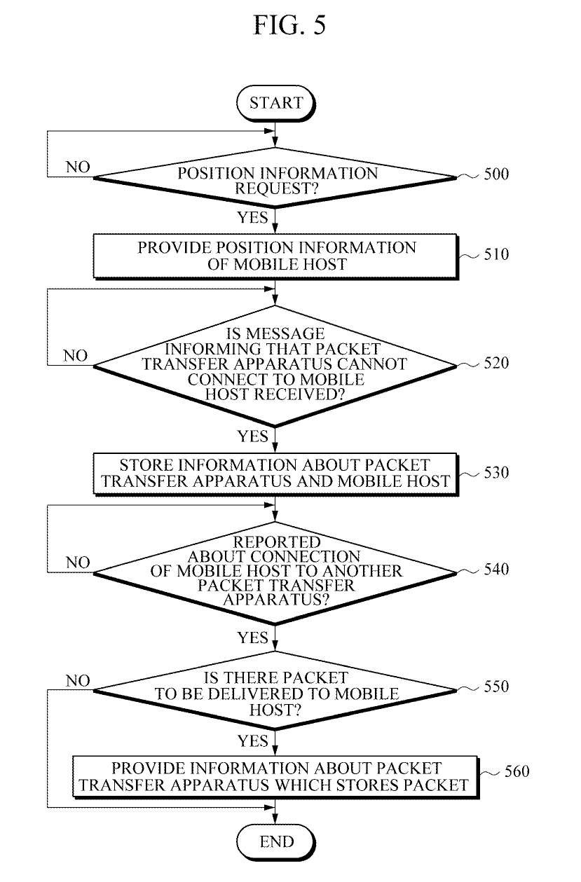

FIG. 5 is a flowchart illustrating an exemplary method of managing the position of a mobile host to ensure continuity of ensure packet delivery. The exemplary method of managing the position of a mobile host may be performed by a home agent or a location management server.

Referring to FIGS. 3 and 5, when requested by a host to provide the position information of a mobile host (500), the position information management unit 310 provides the position information of the mobile host (510). Before that, when a packet transfer apparatus detects the connection of a new mobile host thereto, the packet transfer apparatus reports registration of the new mobile host to a location management apparatus. Accordingly, the location management apparatus stores and manages information about the packet transfer apparatus to which the new mobile host is connected.

When receiving from the packet transfer apparatus a message informing that the packet transfer apparatus cannot connect to a mobile host to which a packet must be transferred (520), the location management unit 310 stores information about the mobile host to which the packet must be transferred and information about the packet transfer apparatus which sent the message informing that the packet transfer apparatus cannot connect to the mobile host (530).

Later, when receiving from another packet transfer apparatus a message reporting that the mobile host is connected to the another packet transfer apparatus (540), the position information provision unit 320 identifies whether there is a packet undelivered to the mobile host (550). When there is a packet undelivered to the mobile host, the position information provision unit 320 sends information about the packet transfer apparatus, which stores the packet, to the another packet transfer apparatus to which the mobile host is connected (560).

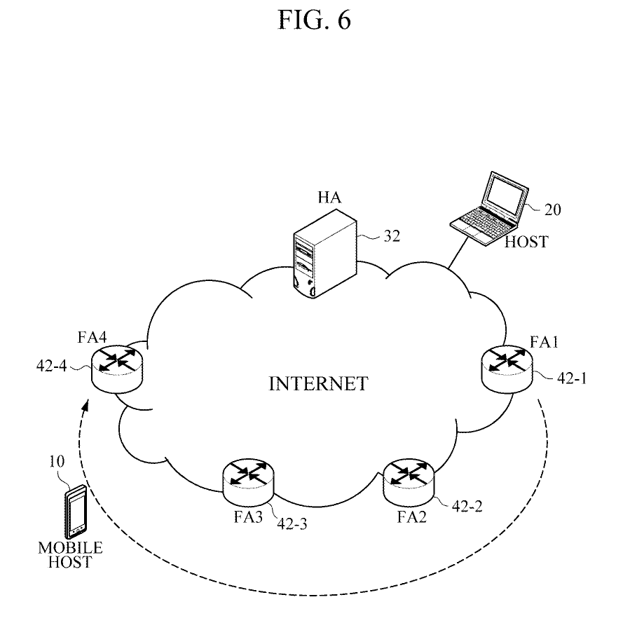

FIG. 6 is a diagram illustrating the configuration of an exemplary packet transfer system for ensuring continuity of packet delivery.

Referring to FIG. 6, the exemplary packet transfer system may be implemented as a mobile Internet system based on mobile IPv4. Here, a location management apparatus may be implemented as a home agent 32, and each packet transfer apparatus may be implemented as a foreign agent 42-1, 42-2, 42-3, or 42-4. Each element of the packet transfer system operates in the same way as that described above with reference to FIG. 1, and thus a redundant description thereof is omitted.

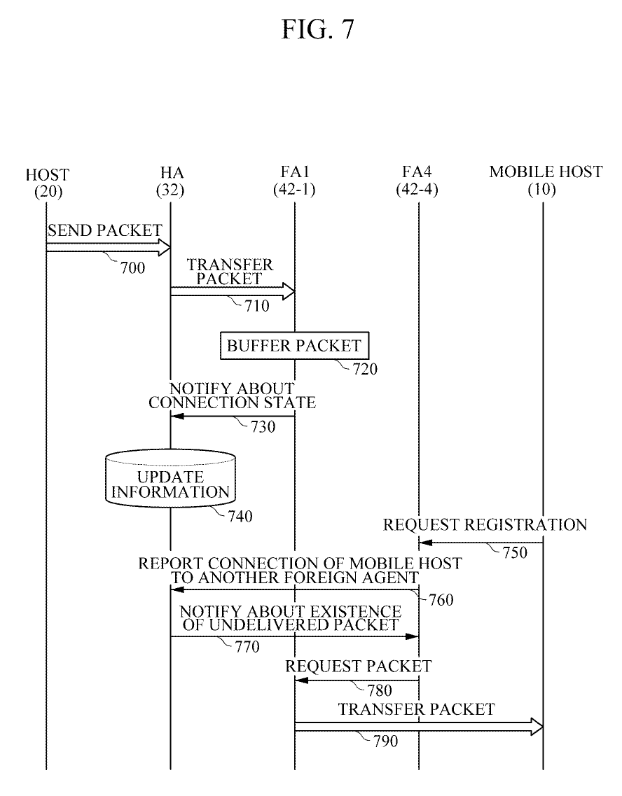

FIG. 7 is a flowchart illustrating an exemplary packet transfer method used in a mobile Internet system to ensure continuity of packet delivery.

Referring to FIG. 7, a host 20 sends a packet to a home agent 32 of a home network to which a mobile host 10 belongs. Here, when the host 20 sends the packet to the home network of the mobile host 10, the home agent 32 intercepts the packet destined for the mobile host 10 (700). Then, the intercepted packet is transferred to a first foreign agent 42-1 with which the position of the mobile host 10 has been registered (710).

The first foreign agent 42-1 identifies that the mobile host 10 is not located in its service area and buffers the packet destined for the mobile host 10 (720). Then, the first foreign agent 42-1 sends to the home agent 32 a message informing that the mobile host 10 is not located in its service area (730).

Based on the message received from the first foreign agent 42-1, the home agent 32 records information indicating that the mobile host 10 is disconnected from the first foreign agent 42-1 in a position database of the mobile host 10 (740).

The mobile host 10 may get reconnected to the Internet when arriving at a fourth foreign agent 42-4 via second and third foreign agents. Accordingly, the mobile host 10 sends a registration request message to the fourth foreign agent 42-4 in order to register its position with the home agent 32 (750).

Then, the fourth foreign agent 42-4 sends the registration request message of the mobile host 10 to the home agent 32 (760). After registering the position of the mobile host 10, the home agent 32 sends to the fourth foreign agent 42-4 a message informing that there is a packet to be transferred to the mobile host 10 and that the packet is buffered in the first foreign agent 42-1 (770).

Based on the message received from the home agent 32, the fourth foreign agent 42-4 requests the first foreign agent 42-1 to forward the packet (780). The first foreign agent 42-1 forwards the buffered packet to the mobile host 10 via the fourth foreign agent 42-4 (790).

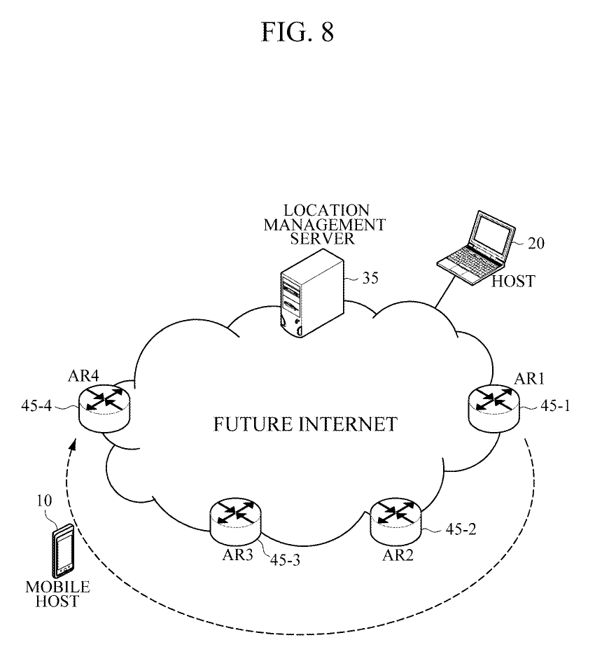

FIG. 8 is a diagram illustrating the configuration of another exemplary packet transfer system for ensuring continuity of packet delivery.

Referring to FIG. 8, the exemplary packet transfer system may also be implemented as a further Internet system. Here, a location management apparatus may be implemented as a location management server 35, and each packet transfer apparatus may be implemented as an access router 45-1, 45-2, 45-3, or 45-4.

The location management server 35 manages the position information of a mobile host 10 on the Internet so as to transfer a packet to the mobile host 10.

To send a packet to the mobile host 10, a host 20 asks the location management server 35 about the position of the mobile host 10. When identifying the position of the mobile host 10, the host 20 sends the packet to the mobile host 10 based on the identified position of the mobile host 10.

For example, the mobile host 10 connected to the first access router 45-1 may move from the first access router 45-1 to the fourth access router 45-4 via the second and third access routers 45-2 and 45-3. In this case, it is assumed that the mobile host 10 cannot connect to the second and third access routers 45-2 and 45-3. That is, the mobile host 10 may be disconnected from the second and third access routers 45-2 and 45-3, for example, due to an unstable communication environment or because the mobile host 10 enters a sleep mode to save power. Thus, when the mobile host 10 is located in a service area of the second or third access router 45-2 or 45-3, if the host 20 transmits a packet to the mobile host 10, the mobile host 10 cannot receive the packet.

In order to solve this problem, the location management server 35 and the first through fourth access routers 45-1 through 45-4 should perform buffering and additional signaling to ensure that the mobile host 10 can receive packets after being reconnected to the Internet, despite unstable network connectivity. Specifically, when the mobile host 10 is not connected to an access router, that is, when the mobile host 10 is located in the service area of the second or third access router 45-2 and 45-3, a packet requested for transfer to the mobile host 10 is buffered in the first access router 45-1 which was previously connected to the mobile host 10.

Then, when the mobile host 10 is connected to the fourth access router 45-4 in a stable manner, the packet buffered in the first access router 45-1 can be delivered to the mobile host 10 without a loss.

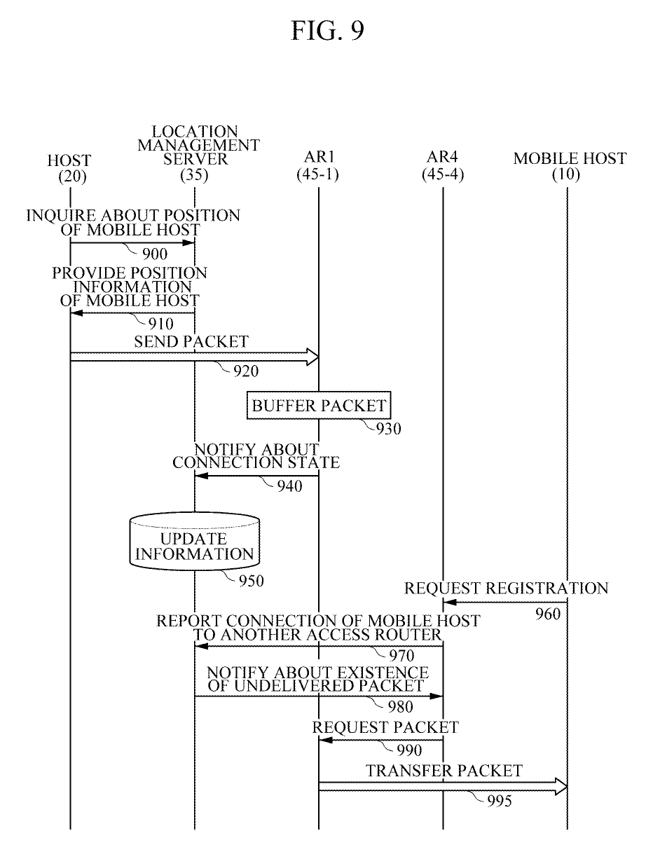

FIG. 9 is a flowchart illustrating another exemplary packet transfer method used in a future Internet to ensure continuity of packet delivery.

Referring to FIG. 9, a host 20 asks a location management server 35 about the position of a mobile host 10 to send a packet to the mobile host 10 (900). Accordingly, the location management server 35 provides a finally registered position of the mobile host 10, e.g., information about a first access router 45-1 to the host 20 (910). Then, the host 20 sends the packet to the first access router 45-1 (920). The first access router 45-1 identifies that the mobile host 10 is not connected thereto and buffers the packet (930). Then, the first access router 45-1 sends to the location management server 35 a message informing that the mobile host 10 is not connected to the first access router 45-1 (940).

The location management server 35 records information indicating that the mobile host 10 is disconnected from the first access router 45-1 in a position database of the mobile host 10 (950).

The mobile host 10 may get connected to the fourth access router 45-4 in a stable manner when arriving at the fourth access router 45-4 via service areas of second and third access routers without being connected to the second and third access routers. When the mobile host 10 is connected to the fourth access router 45-4, the fourth access router 45-4 provides the position information of the mobile host 10 to the location management server 35 (960 and 970).

The location management server 35 notifies the fourth foreign agent 42-4 of the fact that there is a packet to be transferred to the mobile host 10 and that the packet is buffered in the first access router 45-1 (980).

Accordingly, the fourth access router 45-4 requests the first access router 45-1 to forward the packet (990).

In response to the packet forward request from the access router 45-4, the first access router 45-1 identifies the packet buffered for transfer to the mobile host 10 and forwards the buffered packet to the fourth access router 45-4 (995).

A packet delivery method and a location management method described above can be written as a computer program. The program can be stored in a computer-readable storage medium and can be read and executed by a computer. Examples of the computer-readable storage medium include magnetic recording media and optical recording media.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A packet transfer method for ensuring continuity of packet delivery, the method comprising:
identifying whether a packet transfer apparatus is connected to a mobile host by using a state identification unit when requested by a location management apparatus to transfer a packet to the mobile host;
reporting to the location management apparatus that the packet transfer apparatus is disconnected from the mobile host by using a state reporting unit when it is identified that the packet transfer apparatus is disconnected from the mobile host; and
storing the packet which has been requested for transfer to the mobile host by using a packet management unit.

2. The method of claim 1, further comprising, when requested by another packet transfer apparatus to forward the stored packet, forwarding the stored packet to the another packet transfer apparatus by using a packet transfer unit.

3. The method of claim 1, further comprising:
reporting position information of a new mobile host to the location management apparatus by using a host management unit when the new mobile host is connected to the packet transfer apparatus;
obtaining information about the existence of a packet that must be delivered to the new mobile host and information about a packet transfer apparatus which stores the packet from the packet management apparatus by using a packet request unit;
requesting the packet transfer apparatus, which stores the packet, to forward the packet by using the packet request unit; and
receiving the packet from the packet transfer apparatus which stores the packet and sending the received packet to the new mobile host by using a packet transfer unit.

4. A method of managing the position of a mobile host to ensure continuity of packet delivery, the method comprising:
matching information about a mobile host with information about a packet transfer apparatus which is disconnected from the mobile host and storing the matched information by using a position information management unit when receiving from the packet transfer apparatus a message informing that the packet transfer apparatus is disconnected from the mobile host to which a packet must be transferred; and
providing information about the packet transfer apparatus which is disconnected from the mobile host by using a position information provision unit when reported by another packet transfer apparatus that the mobile host is connected to the another packet transfer apparatus.

5. The method of claim 4, further comprising:
creating a database of position information of the mobile host and managing the database by using the position information management unit when reported by a packet transfer apparatus that the mobile host is connected to the packet transfer apparatus; and
providing position information of a mobile host by using the position information management unit when requested by a host to provide the position information of the mobile host.

6. A packet transfer apparatus for ensuring continuity of packet delivery, the apparatus comprising:
a state identification unit configured to identify whether a packet transfer apparatus is connected to a mobile host when requested by a location management apparatus to transfer a packet to the mobile host;
a state reporting unit configured to report to the location management apparatus that the packet transfer apparatus is disconnected from the mobile host when it is identified that the packet transfer apparatus is disconnected from the mobile host;
a packet storage unit configured to store packets which are to be transferred to mobile hosts; and
a packet management unit configured to store the packet, which has been requested for transfer to the mobile host, in the packet storage unit.

7. The apparatus of claim 6, wherein the packet management unit is further configured to extract the stored packet from the packet storage unit when requested by another packet transfer apparatus to forward the stored packet and the apparatus further comprises a packet transfer unit which transfers the packet extracted by the packet management unit in response to the packet forward request to the another packet transfer apparatus.

8. The apparatus of claim 6, further comprising:
a host management unit configured to report position information of a new mobile host to the location management apparatus when the new mobile host is connected to the packet transfer apparatus;
a packet request unit configured to request a packet transfer apparatus to forward a packet when receiving from the location management apparatus a message informing about the existence of the packet that must be delivered to the new mobile host and information about the packet transfer apparatus which stores the packet; and
a packet transfer unit configured to receive the packet from the packet transfer apparatus which stores the packet and send the received packet to the new mobile host.

9. The apparatus of claim 6, wherein the packet transfer apparatus is one of an access node, a foreign agent, and a router.

10. An apparatus for managing the position of a mobile host to ensure continuity of packet delivery, the apparatus comprising:
a position information storage unit configured to store information about the position of a mobile host and information about a packet transfer apparatus to which the mobile host belongs;
a position information management unit configured to manage information stored in the position information storage unit and, when receiving from a packet transfer apparatus a message informing that the packet transfer apparatus is disconnected from a mobile host to which a packet must transferred, store information about the disconnection of the packet transfer apparatus from the mobile host in the position information storage unit; and
a position information provision unit configured to extract the information about the packet transfer apparatus which is disconnected from the mobile host and provide the extracted information to another packet transfer apparatus when reported by the another packet transfer apparatus that the mobile host is connected to the another packet transfer apparatus.

11. The apparatus of claim 10, wherein the position information management unit is further configured to store position information of the mobile host in the position information storage unit when reported by a packet transfer apparatus that the mobile host is connected to the packet transfer apparatus and provides position information of a mobile host when requested by a host to provide the position information of the mobile host.

12. The apparatus of claim 10, wherein the location management apparatus is a home agent.
